(19) United States
(12) Patent Application Publication
(10) Pub. No.: US 2017/0208262 A1
(43) Pub. Date: Jul. 20, 2017

(54) Digital enhanced vision system

(71) Applicant: SAGE TECHNOLOGIES, LTD., Warminster, PA (US)

(72) Inventors: Wesley M. Sheridan, Chalfont, PA (US); Julius A. Olita, Warrington, PA (US); Russell O'Rourke, Telford, PA (US)

(73) Assignee: SAGE TECHNOLOGIES, LTD., Warminster, PA (US)

(21) Appl. No.: 14/998,979

(22) Filed: Mar. 11, 2016

Related U.S. Application Data
(60) Provisional application No. 62/177,384, filed on Mar. 12, 2015.

(51) Int. Cl. H04N 5/33; G06K 9/00; H04N 5/225

(52) U.S. Cl. CPC H04N 5/332; H04N 5/2252; G06K 9/00771

(57) ABSTRACT

A digital enhanced vision system assembled and adapted for mobile use by personnel in surveillance operations. The inventive system comprises separate infrared sensor channels, one featuring a short wave infrared (SWIR) camera and the other, a thermal imaging camera with a micro-bolometer for long wave infrared (LWIR) detection, each of the cameras being fixed and similarly directed upon the viewed scene to collect real-time visual data of the scene in their respective infrared bands. Respective data outputs from the SWIR and LWIR cameras are connected to an advanced vision processor for digitally fusing the respective data on a pixel-by-pixel basis providing significant enhancements to the viewed scene in a visual image presented for biocular display to both eyes of the user. The system is housed for helmet-mounted operation further including an adjustable mounting clip to releasably engage the system to the front of a standard helmet and a separate battery back connected by cabling routed alongside the helmet and adapted to mount upon the rear of the helmet.

### CROSS-REFERENCE TO RELATED APPLICATION

This application claims the benefit of U.S. Provisional Application Ser. No. 62/177,384 filed Mar. 12, 2015 for a Digital Enhanced Vision System.

### GOVERNMENT RIGHTS LEGEND

This invention was made with government support under Phase I SBIR Government contract FA-8650-07-M6792 and Phase II SBIR Government contract FA-8650-08-C-6849 awarded by the United States Air Force. The government has certain rights in the invention.

### BACKGROUND OF THE INVENTION

The present invention relates to the field of night vision systems designed for viewing images in a darkened or obscured environment and more particularly, to an improved digital enhanced vision system designed for helmet-mounted operation and capable of digitally fusing real-time high resolution imagery data from separate short wave infrared and long wave infrared thermal sensors on a pixel-by-pixel basis to provide significant enhancements to a viewed scene in day or night and under obscured conditions such as smoke or fog.

Military and law enforcement personnel have long used night vision systems to improve their visual perception in low light conditions. In the history of development of night vision systems, various sensor technologies have been used to collect radiation data and therefrom produce recognizable images from a darkened or obscured environment or scene under observation. In the early generations of these night vision systems, low levels of ambient light not viewable to the naked eye were collected optically and amplified electronically to viewable levels by one or more image intensifier tubes that would allow an operator or user of the system to see very low level wavelengths of radiation in the visible spectrum and convert certain non-visible light sources, such as near-infrared to visible. These image intensifier tubes generally work by amplifying the number of received photons taken from the ambient light while keeping the resulting photons spatially separated so that the original image formed by the ambient light is not distorted or blurred. While these image intensifier tubes have been effective in providing substantial photon amplification for night vision purposes, they are fundamentally analog sensors that need ambient light to be available in order to produce satisfactory images and do not effectively see through obscure conditions such as smoke, heavy fog, and dust, also being ineffective in seeing personnel hidden under camouflage.

Infrared sensors have provided additional technology useful in night vision systems by generating images of people and objects through their emission of thermal energy or radiation. These infrared sensors are devices sensitive to emissions in limited spectral ranges of infrared radiation. In general, persons and objects emit infrared radiation across a spectrum of wavelengths, but sometimes only a limited region of the spectrum is of interest because sensors usually collect radiation only within a specific bandwidth, the most typical being those of the near infrared (NW) wavelength band (approximately 750-1,400 nm), the short wave infrared (SWIR) band (approximately 1,400-3,000 nm), the medium wave infrared (MWIR) band (approximately 3,000-8,000 nm), and the long wave infrared (LWIR) or so-called thermal infrared band (approximately 8,000-15,000 nm). The NIR band is the region closest in wavelength to the visible band of radiation detectable by the human eye and for night vision purposes, NIR band sensors rely upon there being reflected ambient light to make object recognition. Because of this characteristic dominance by reflective light, image intensifiers typically will operate into the NIR band.

While SWIR band sensors also rely to some degree upon reflective light and therefore benefit from illumination upon the scene, these sensors evidence far more sensitivity to photons emissions in the SWIR band and have higher quantum efficiency and greater spectral response than conventional image intensifiers. SWIR cameras detect reflected light at wavelengths invisible both to the human eye and traditional night-vision technology and operate effectively in starlight conditions, relying on illumination from so-called “atmospheric night glow”, a phenomenon created by hydroxyl ion emissions in the shortwave infrared portion of the spectrum. In comparison to the image intensifier sensors, the SWIR sensors and their associated cameras afford increased visibility through dust, smoke and haze in daylight conditions, and unlike the analog image intensifiers devices, the SWIR sensors are capable of providing digital output that can be processed and enhanced to provide greater resolution and versatility in image production and display.

Characteristically distinct from the SWIR band sensors, those in the LWIR band, sometimes referred to as “thermal infrared”, are dominated by emitted thermal energy rather than by reflective light in producing images of a viewed scene and have long been used in night vision applications by capturing that radiation in the upper portion of the infrared spectrum that is emitted as heat by persons or objects within the scene. While these LWIR band sensors in so-called thermal-imaging systems have been effective in producing useful images not only of darkened environments but also those obscured by smoke, dust or fog, they have typically experienced problems in maintaining the stability of these heat-sensitive sensors and as a drawback, have not generally had sufficient resolution and sensitivity to provide fully acceptable imagery of the scene.

The concept of fusing or blending multiple sensor elements in a night vision system has been proposed and implemented in an attempt to derive benefits of one sensor element over another with the design intent to produce a fused image that is better in quality than one produced using just one sensor or the other. Prior art examples of such fusion night vision systems are found shown and described in U.S. Pat. No. 6,560,029 to Dobbie et al.; U.S. Pat. No. 7,345,277 to Zhang; U.S. Pat. No. 7,864,432 to Ottney; and U.S. Pat. App. Pub. 2012/0257005 to Browne. While these and other existing fusion night vision systems have generally performed satisfactorily in improving the visual imaging of darkened and obscured environments by taking advantage of the capabilities of both the image intensifier in the visible and NIR bands as well as the thermal infrared band of sensors, particularly those in the LWIR, they have not been completely satisfactory in fusing all the sensor capabilities provided by the SWIR and the LWIR bands for increased sensitivity to thermal emissions and improved visual enhancements through the use of state-of-the-art digital processing of the collected emissions. Furthermore, the fused night vision systems of the prior art, particularly those employing image intensifiers to collect emissions in the visual light and NIR range, have not afforded the most favorable package desired for helmet-mounted transport upon military personnel.

Therefore, a need exists for an improved fusion night vision system operating exclusively within the infrared sensor bands and capable of producing digital enhanced imaging for its operator in a finished arrangement best designed for helmet-mounted operation.

### SUMMARY OF THE INVENTION

Accordingly, it is a general purpose and object of the present invention to provide an improved night vision system for use by military and law enforcement personnel that is capable of producing digitally enhanced images of darkened and obscured environments with minimal impact on normal operations of the user personnel.

A more particular object of the present invention is to provide an improved helmet-mounted vision system operating exclusively within the infrared sensor bands and capable of digitally fusing real-time high resolution imagery data collected from separate infrared sensors to provide significant enhancements to a viewed scene in day or night and under obscured conditions such as smoke, dust, haze or fog.

Another object of the present invention is to provide an improved digital enhanced vision system for surveillance operations that can provide imaging capability on a continuous 24/7 time schedule during each month of the year even when ambient light is unavailable.

Still another object of the present invention is to provide an improved digital enhanced vision system for military surveillance operations that is lightweight and portable and made conformal to standard helmets for ready engagement and balanced mounting upon the head of the operator, reducing head and neck strain over extended usage without impairing normal head movements and sighting.

A still further object of the present invention is to provide a digital enhanced vision system that is user-friendly in its controls and reliable in its performance, affording greater viewability and recording capabilities in all darkened and obscured environments.

Briefly, these and other objects of the present invention are accomplished by an improved digital enhanced vision system assembled and adapted for mobile use by personnel in surveillance operations. The inventive system comprises separate infrared sensor channels, one featuring a short wave infrared (SWIR) camera and the other, a thermal imaging camera with a micro-bolometer for long wave infrared (LWIR) detection, each of the cameras being fixed and similarly directed upon the viewed scene to collect real-time visual data of the scene in their respective infrared bands. Respective data outputs from the SWIR and LWIR cameras are connected to an advanced vision processor for digitally fusing the respective data on a pixel-by-pixel basis providing significant enhancements to the viewed scene in a visual image presented for biocular display to both eyes of the user. The system is housed for helmet-mounted operation further including an adjustable mounting clip to releasably engage the system to the front of a standard helmet and a separate battery back connected by cabling routed alongside the helmet and adapted to mount upon the rear of the helmet.

The present system provides various advanced control capabilities by means of the digital processing techniques that include digital enhanced zoom, image stabilization for better viewing while moving, near-far focus, parallax correction, and moving target indicators to assist the user in the improved detection of threats.

For a better understanding of these and other aspects of the present invention, reference should be made to the following detailed description taken in conjunction with the accompanying drawings in which like reference numerals and character designate like parts throughout the figures thereof.

### BRIEF DESCRIPTION OF THE DRAWINGS

For a fuller understanding of the nature and objects of the present invention, references in the detailed description set forth below shall be made to the accompanying drawings in which:

FIG. 1 is a front perspective view of a preferred embodiment of a digital enhanced vision system assembled and mounted upon a protective helmet for use in accordance with the present invention;

FIG. 2 is a front perspective view of the digital enhanced vision system of FIG. 1 shown here removed from its protective housing;

FIG. 3 is an enlarged side perspective view of the mounted digital enhanced vision system of FIG. 1;

FIG. 4 is an enlarged side perspective view of the mounted digital enhanced vision system of FIG. 1 viewed here from the opposite side of that shown in FIG. 3;

FIG. 5 is a bottom plan view of the present digital enhanced vision system of FIG. 1 separated from its mounted position at the front end of the protective helmet;

FIG. 6 is a block diagram of the present digital enhanced vision system; and

FIG. 7 is a further block diagram of the present inventive system similar to FIG. 6 with hardware components thereof shown.

### DESCRIPTION OF THE INVENTION

The following serves to describe a preferred embodiment of the present invention and the best presently contemplated mode of its production and practice. This description is further made for the purpose of illustrating the general principles of the invention but should not be taken in a limiting sense, the scope of the invention being best determined by reference to any associated claims.

Referring to the drawings, the following is a list of component elements of the present digital enhanced vision system, generally designated 10, and those associated assemblies employed in connection with the present invention:
10 digital enhanced vision system;
12 electro-optic sensor module;
14 housing;
15 keypad control panel;
15a control select switch;
15b zoom-out control;
15c zoom-in control;
15d display brightness control;
16 biocular display modules;
17 front shroud;
18 power module;
18a battery pack;
18b retaining straps;
19 electrical cabling;
20 rail bracket members;
22 mounting latch;
22a latch body;
22b lock/release lever;
22c vertical adjust tab;
24 long-wave infrared (LWIR) thermal sensor;
24a LWIR objective lens optics;
24b LWIR micro-bolometer;
26 short-wave infrared (SWIR) sensor camera;
28 SWIR lens;
30 microprocessor control board;
32 vision processor module;
34 display hinges;
36 display adjustment mechanism;
36a lateral adjustment control;
36b fore/aft adjustment control;
38 mode selection control switch;
40 power control switch; and
H protective helmet.

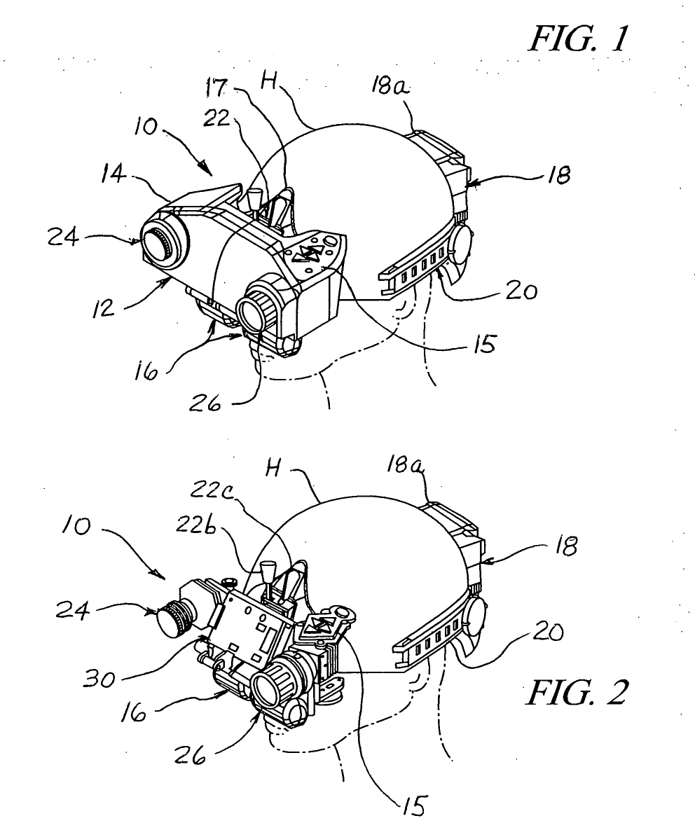

Referring initially to FIG. 1, the present digital enhanced vision system 10 is shown mounted upon a protective helmet H such as that worn by personnel in military combat or surveillance operations. In accordance with the present invention, the present digital enhanced vision system 10 includes an electro-optic sensor module 12 assembled and enclosed within a protective housing 14 with a set of biocular display modules 16 electrically connected to the sensor module and mechanically hinged at the bottom of the housing so that the display modules may rotate into a viewing position immediately forward of the respective eyes of the personnel user of the present system. The electro-optical sensor module 12 is adapted to be releasably mounted to the forward portion of the helmet H and made adjustable in its position by means of a mounting latch 22 formed and adapted to engage a conventional shroud member 17 typically secured centrally upon the front of the helmet. As detailed further below, the mounting latch 22 is secured to the exterior of the housing 14 midway along its rearward surface to correspondingly engage the shroud 17 and is adapted to provide quick and easy mounting of the electro-optical sensor module 12 with a vertical adjustment feature that assures that the display modules 16 are set properly in position relative to the eyes of the personnel user when mounted on the helmet H.

The present digital enhanced vision system 10 further includes a power module 18 separate from the electro-optical sensor module 12 and biocular display modules 16 and adapted to mount at the rear of the protective helmet H. The power module 18 is contoured in its exterior configuration to conform to the surface of the helmet H and designed to hold a battery pack 18a releasably contained in a cartridge form for supplying DC operating voltage to both the electro-optical sensor module 12 and biocular display modules 16 via electrical cabling 19 extending from the power module. The electrical cabling 19 from the power module 18 may be routed along the sides of the helmet H through and beneath a specially adapted rail bracket member 20 mounted on either side of the protective helmet H. A most suitable form of the rail bracket member 20 is a modified version of the commercially available Picatinny Rail Adapter with its interior configuration of ribs and channels and end openings modified for proper fit and clearance of the cabling routed therethrough. Alternatively to modifying the conventional rail adapter and permanently captivating the cabling 19, a hold-down strap of hook and loop fasteners, such as those made of Velcro brand fabric material, can be mounted upon the standard rail adapter and used to securely maintain the cabling along the side of the helmet H.

The rail bracket member 20, particularly at its rearward edge, may also be used to further provide a point of releasable attachment for the power module 18 on each side of the helmet H. Retaining straps 18b, one attached to each side of the power module 18 and extending therefrom, are used to secure the mounting of the power module to the rear of the helmet H by means of releasable attachment with the rearward edge of the rail bracket member 20. This means for mechanical attachment of the power module 18 to the rail bracket member 20 along together with its contoured exterior surface formed and fitted to conform with the rear of the protective helmet H contributes to a secure but releasable mounting of the power module to the back of the helmet opposite from the mounted attachment of the respective sensor and display modules 12 and 16 at the front of the helmet. It should be noted and understood that the described mounting configuration of the present digital enhanced vision system 10 with the combined sensor and display modules 12 and 16 at the front of the helmet H and the power module 18 at the rear distributes the overall weight of the system more evenly upon the user personnel and decreases the resultant moment arm of the helmet-mounted system adversely affecting the wearing personnel during operational use. The separate mounted location of the power module 18 at the rear of helmet H also removes the adverse effect of heat generated by battery pack 18a from the processing operations of the electro-optic sensor module 12 at the front of the helmet.

Referring now to FIG. 2 in conjunction with FIG. 1, the electro-optical sensor module 12 incorporates a long-wave infrared (LWIR) sensor camera 24 forwardly directed and mounted on one side of the sensor module and a short-wave infrared (SWIR) sensor camera 26 similarly directed and mounted on the opposite side. The LWIR sensor camera 24 is a compact digital unit that is a commercially available with an associated objective lens 24a having a wide field-of-view secured at its front end and a conventional micro-bolometer detector array 24b optically coupled and secured to the back of the objective lens. The LWIR sensor camera 24 is designed and intended to deliver high resolution infrared images in the long-wave (8-14 μm) spectral band with the objective lens 24a collecting all available radiation emanating from the viewed site in the long-wave spectral band and directing such LWIR upon the micro-bolometer array 24b where it is detected and converted to a thermal images. The micro-bolometer detector array should generally feature a high sensitivity in the long wave infrared spectral band and exhibit high uniformity and very short thermal time constants making them ideal for use in portable thermal imagers as well as to observe and differentiate objects in motion. The LWIR sensor camera 24 is preferably of the type having standard digital interface for input/output data signal transmission. A suitable LWIR sensor camera 24 for implementation in the electro-optical sensor module 12 is the FLIR Tau2 series camera produced by FLIR Commercial Systems, Inc. having an uncooled 640×480 micro-bolometer detector array with a variety of different infrared objective lenses available.

Also incorporated into the electro-optical sensor module 12 is a short-wave infrared (SWIR) sensor camera 26 that is forwardly directed and mounted opposite to the long-wave infrared (LWIR) sensor camera 24 within the protective housing 14. The SWIR sensor camera 26 is a compact digital unit that is commercially available and fitted for assembly with a specially coated SWIR lens 28 adjustable for focus and having a wide range of field-of-views. The SWIR sensor camera 26 and associated SWIR lens 28 combine in collecting detected photons reflected or absorbed by an object in view and together provide a strong contrast required for high resolution imaging using ambient star light and background radiance or nightglow as natural SWIR emitters. The SWIR sensor camera 26 preferably employs indium gallium arsenide (InGaAs) technology with the InGaAs photodetectors having high SWIR sensitivity over the standard SWIR wavelength band (0.8-1.70 μm) to produce high resolution SWIR images for digital processing. A suitable SWIR camera 26 for use in the electro-optical sensor module 12 is one of the CSX Model Series of Sensors Unlimited Micro-SWIR cameras manufactured by UTC Aerospace Systems. Particularly the 640CSX model having a 640×512 pixel focal plane array with a Camera Link® digital interface output.

An available working alternative to the SWIR sensor camera 26 found to be an effective substitute therefor in the present digital enhanced vision system 10 is an electro-optical sensor referred to as a digital I-squared or DP sensor based on the Electron Bombarded Active Pixel Sensor (EBAPS) technology of Intevac, Inc. and selected to operate in the near-infrared (NIR) band of light spectrum. The EBAPS technology is based on a III-v semiconductor photocathode in proximity-focus with a high resolution, backside-thinned, CMOS chip anode. Such a DI² sensor captures light in the selected band and amplifies photons, which are then collected on a solid-state detector and are effectively digital in nature. Once in the digital domain, the imagery can be processed, unlike traditional I-squared (I²) in which the image result is generated by the photons impinging onto a phosphor type display. In the alternative DI² sensor, the electrons emitted by the photocathode are directly injected in the electron bombarded mode into the CMOS anode, where the electrons are collected, amplified and read-out to produce digital video directly out of the sensor.

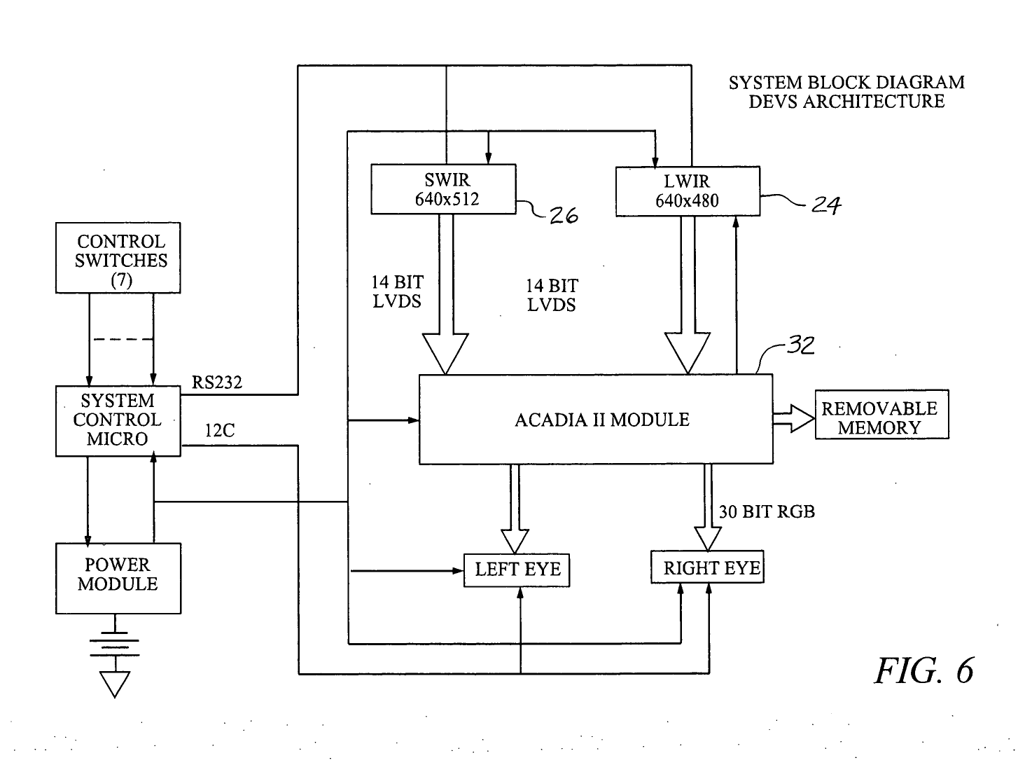

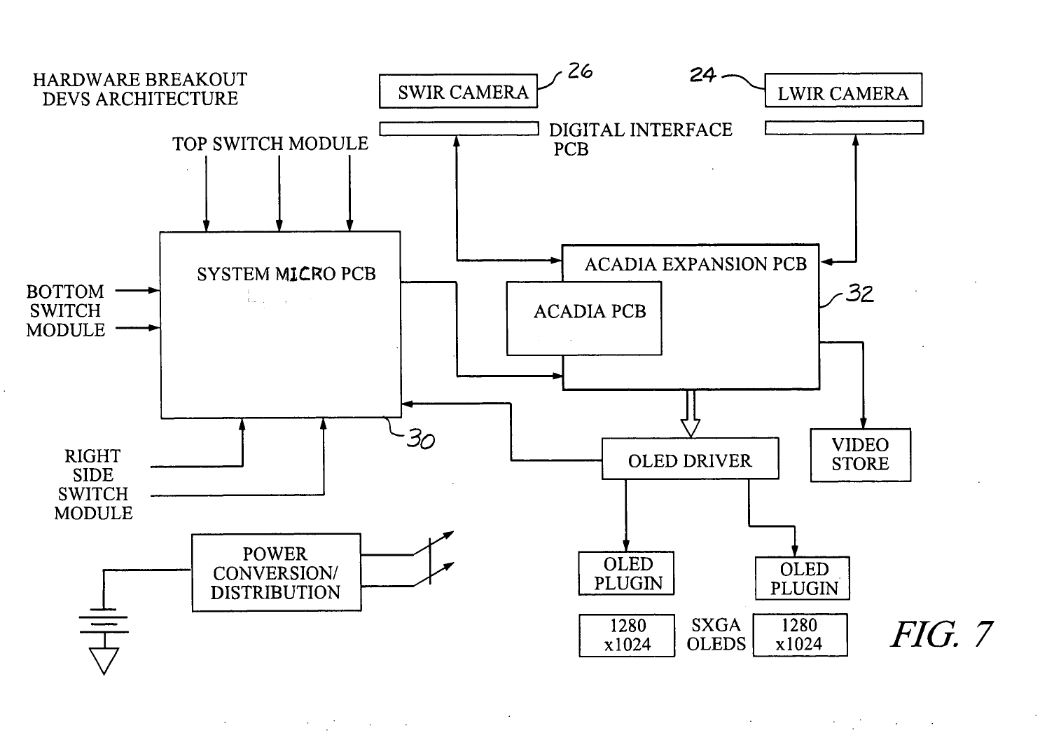

Microprocessor electronics 30 incorporating integrated circuitry for operational control of the present vision system 10 and enhanced digital signal processing between the electro-optical sensor module 12 and the display modules 16 is board-assembled and operatively connected within the housing 14 intermediate of the long-wave infrared (LWIR) sensor camera 24 and the SWIR sensor camera 26. As described in greater detail with respect to FIGS. 6 and 7, the microprocessor electronics 30 provides integrated electronics for the power distribution, control switches and displays as well as providing camera interface electronics. The microprocessor electronics 30 controls the operational function of the primary operating modes of the digital enhanced vision system 10 including the LWIR/thermal mode, the SWIR mode, and the digitally fused LWIR/SWIR mode and further provides processing controls for sensor fusion, image enhancements and stabilization, and zoom controls. An integrated video processor module 32 serves as the central processing unit of the microprocessor electronics 30 with programmable capabilities that will provide real-time digital processing of the LWIR and SWIR image signal data and digitally fuse the signal data on a pixel-by-pixel basis with real-time digital enhancements. A suitable video processor module 32 currently preferred for use in the present digital enhanced vision system 10 is an ACADIA® II embedded video processor System-on-a-Chip (SoC) product of SRI International that is an advanced vision processing technology in a single integrated circuit capable of fusing together feeds from multiple video sources. Further capabilities of the integrated video processor include full color, full resolution processing up to 1280×1024 and 30/60 Hz, 1280×1024 RGB video output with on-screen display processing, real-time, low latency processing, and three-channel, pattern selective adaptive fusion for night vision. A specially configured FGPA or field-programmable gate array may be adapted and also serve as the integrated video processor 32 incorporated into the microprocessor electronics 30 of the present electro-optical module 12.

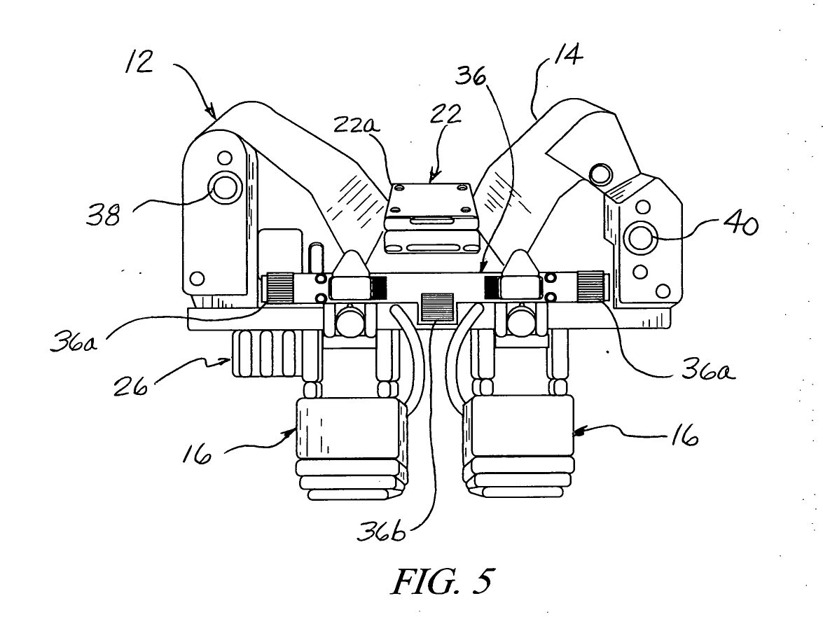

The mounting latch 22 includes a latch body 22a that is secured to the rearward surface of the housing 14, as best seen in FIG. 5, and adapted to slide into engagement with the helmet shroud 17. Separate lever-like members, a locking lever release arm 22b and a vertical adjustment tab 22c, extend from respective connections within the latch body 22a to positions sufficiently above the top surface of the housing 14 to ease their reach and manipulation by the user/operator. The locking lever release arm 22b is pivotally secured within the mounting latch body 22a to selectively lock the electro-optical module 12 in place upon the helmet H or enable a quick release thereof, when desired, and the vertical adjustment tab 22c, when pressed upon, allows movement of the level of the electro-optical module in order to adjust the vertical positioning of the display modules 16 to best suit the user/operator.

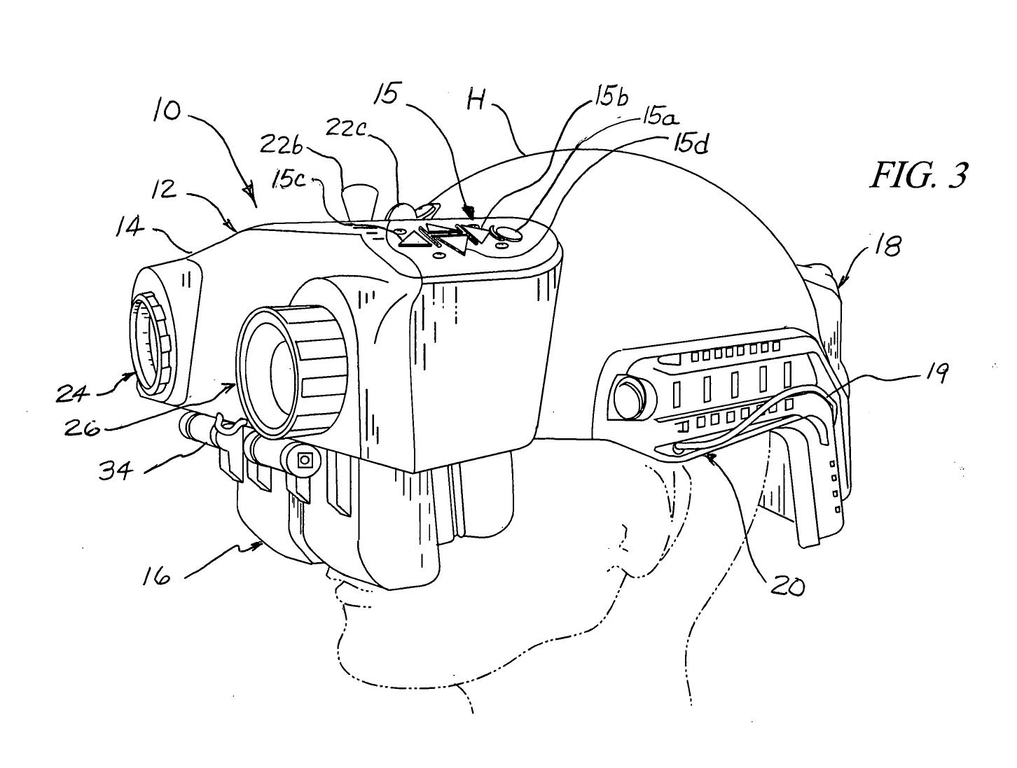

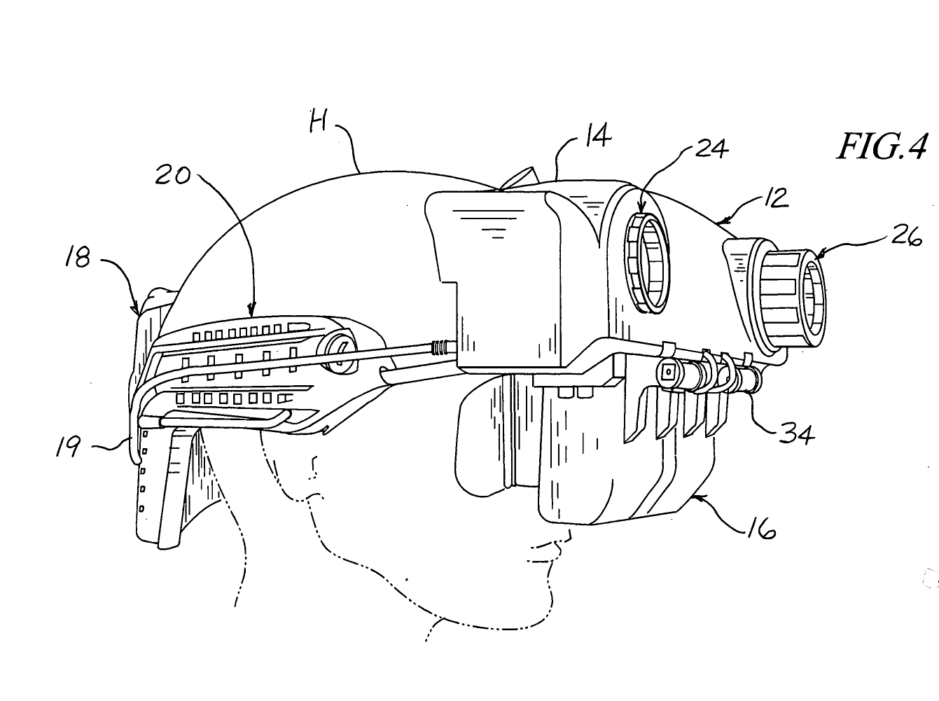

Referring now more particularly to FIGS. 3, 4 and 5 in conjunction with FIGS. 1 and 2, the keypad control panel 15 for the present digital enhanced vision system 10 is located on the top of the housing 14 in a simplified configuration within easy reach of the user/operator. In its configuration, the keypad control panel 15 includes a control select switch 15a for selecting operational controls for the vision system 10 in the SWIR, LWIR or Fused mode. Associated zoom controls including a zoom-in control pad 15c at the front of the keypad panel and a zoom-out control pad 15b rearwardly situated on the keypad enable the user/operator to enlarge or reduce the images viewed on the screens of the display modules 16. Brightness control pads 15d are further provided and laterally situated on the keypad panel 15 in opposite directions for selectively increasing or decreasing the brightness of the images viewed. It should be noted that the control panel 15 can be adapted to provide rotary knobs in place of the key pad elements for some or all of the controls described.

The pair of display modules 16 are biocular in their image presentation with the same resulting image appearing on each module. Each display module 16 is adapted to rotate upon respective display hinges 34 at the bottom of housing 12 and by means of a detent function able to move 90° up and down into a proper position for best viewing the resulting display images of the present vision system 10 immediately forward and proximate to the respective eyes of the user/operator. The display modules 16 are designed for rectangular view access and are inverted to reposition images planes for improved vertical positioning. In addition to the vertical positioning adjustment effected through the mounting latch 22, the display modules 16 are further adjustable fore and aft as well in their lateral positions through a display adjustment mechanism 36 assembled in connection with the display modules and secured in fitted attachment beneath the housing 14. As best seen in FIG. 5, a pair of rotatable screw controls 36a, one on either side of the display adjustment mechanism 36 finely adjust the lateral position of each of the display modules 16, while a central roller control 36b fitted within the middle of the display adjustment mechanism moves the display modules together fore or aft to suit the user/operator. Also viewed in FIG. 5, separate mode selection and power control switches 38 and 40 for the respective SWIR sensor camera 26 and the LWIR sensor camera 24 are positioned on the bottom side of the housing 14 immediately beneath and proximate to the cameras on either side of the electro-optical sensor module 12.

In reference to FIG. 6, the electronic system architecture of the digital enhanced vision system 10 comprises the sensor subsystem including the LWIR sensor camera 24 and SWIR sensor camera 26 and their associated interface electronics; the control processor subsystem including the microprocessor electronics board 30 and vision processor module 32; the biocular display subsystem including the display modules 16 for both eyes; and the power subsystem including the power module 18 and its battery pack 18a. The key hardware components of those primary subsystems and their associated electronic signal linking are shown in FIG. 7. In operation mounted upon helmet H, the present digital enhanced vision system 10 may be selected for functioning in the LWIR, SWIR, or Fused mode, with the respective LWIR and SWIR camera sensors, 24 and 26, being activated accordingly by the user/operator in visual surveillance of a site. In the separate LWIR and SWIR. sensor modes of operation, high resolution LWIR/thermal and SWIR images are respectively produced in real-time with digital processing enhancements to the images viewed on the display modules 16. In the Fused mode of operation with both the LWIR and SWIR sensor cameras, 24 and 26, respectively, being activated, the high resolution images from the respective sensor cameras are further enhanced and digitally fused on a pixel-by-pixel basis providing significant improvements to the viewed scene. In Fused mode processing, the high resolution SWIR. image of a scene is augmented with a colorized heat map generated from the highest differential temperature LWIR/thermal images of the same scene to add significant contrast to objects of interest in the resultant digitally fused image that improves target recognition and detection by the user/operator.

Therefore, it is apparent that the described invention provides an improved night vision system suitable for use by military and law enforcement personnel that is capable of producing digitally enhanced images of darkened and obscured environments with minimal impact on normal operations of the user personnel. More particularly, the disclosed invention provides an improved helmet-mounted vision system operating exclusively within the infrared sensor bands and capable of digitally fusing real-time high resolution imagery data collected from separate infrared sensors to provide significant enhancements to a viewed scene in day or night and under obscured conditions such as smoke, haze or fog. The disclosed digital enhanced vision system is ideally suited for military reconnaissance and surveillance operations, particularly in darkened and obscured conditions, providing high resolution imaging capability on a continuous 24/7 time schedule during each month of the year even when ambient light is unavailable. The present digital enhanced vision system, as described and shown, is lightweight and portable and made conformal to standard military helmets for ready engagement and balanced mounting upon the head of the operator, reducing head and neck strain over extended usage without impairing normal head movements and sighting. The present inventive system is also user-friendly in its controls and reliable in its performance, affording greater visual enhancements and recording capabilities in all darkened and obscured environments.

Obviously, other embodiments and modifications of the present invention will readily come to those of ordinary skill in the art having the benefit of the teachings presented in the foregoing description and drawings. Alternate embodiments of different shapes and sizes, as well as substitution of known materials or those materials which may be developed at a future time to perform the same function as the present described embodiment are therefore considered to be part of the present invention. Furthermore, certain modifications to the described embodiment that serve to benefit its usage are within the scope of the present invention. Accordingly, it is understood that this invention is not limited to the particular embodiment described, but rather is intended to cover modifications within the spirit and scope of the present invention as expressed in the appended claims.

What is claimed is:

1. A helmet-mounted vision system for providing digitally enhanced visual images of an observed scene to a user, comprising:
electro-optical sensor means for generating a pair of separate digital signal channels of real-time video data collected from the observed scene, one of said pair of signal channels being in a long-wave thermal infrared band and the other being in a short-wave infrared band;
microprocessor control means operatively connected to said electro-optical sensor means for digitally fusing the separate digital signal channels of real-time video data on a pixel-by-pixel basis to produce an enhanced digital image signal of the observed scene;
a housing for containing said electro-optical sensor means and said microprocessor control means, said housing being adapted for releasable attachment to a helmet worn by the user;
biocular display means coupled to said housing and operatively connected to said microprocessor control means for displaying visual images of the observed scene based on the enhanced digital image signal; and
a power module adapted to engage the helmet and releasably connected to said housing for supplying operating voltages to said electro-optical sensor means, said microprocessor control means and said biocular display means.

2. A helmet-mounted vision system according to claim 1, wherein said electro-optical sensor means comprises:
a long-wave thermal infrared sensor camera mounted within said housing having a micro-bolometer detector array forwardly facing in the direction of the observed scene; and
a short-wave infrared sensor camera mounted apart from said long-wave infrared sensor camera within said housing similarly facing in the direction of the observed scene,
wherein each of said infrared cameras produce a separate digital signal channel of real-time video data collected from the observed scene.

3. A helmet-mounted vision system according to claim 2, wherein said microprocessor control means comprises:
a programmable video processor module operatively connected to said long-wave and short-wave infrared sensor cameras to provide real-time digital processing of the respective signal channels of video data therefrom; and
mode control means for selectively fusing the respective signal channels of infrared image data or processing the respective signal channels separately.

4. A helmet-mounted vision system according to claim 3, wherein said biocular display means comprises:
a pair of separate display modules each connected to said video processor module for producing the same resultant image on each module.

5. A helmet-mounted vision system according to claim 1, further comprising:
a latch mechanism attached to said housing and adapted to engage a forward portion of the helmet, said latch mechanism being assembled having lever-like members extending therefrom to selectively lock the housing in place upon the helmet or enable a quick release thereof.

6. A helmet-mounted vision system according to claim 5, wherein said power module is contoured and configured to conform to a rear portion of the helmet and be releasably mounted thereon in a position opposite to the mounted position of said housing.

7. A helmet-mounted vision system according to claim 6, further comprising:
electrical cabling routed from said power module to said electro-optical sensor means, said microprocessor control means and said biocular display means; and
a rail bracket member mounted along the helmet and adapted in form to secure the routed cabling in place along either side thereof.

8. A digital enhanced vision system for use by surveillance personnel as a helmet attachment to provide improved visual images of an observed scene, comprising:
electro-optical sensor means for generating a pair of separate digital signal channels of real-time video data collected from the observed scene in distinct infrared bands, one of said pair of signal channels being in a long-wave thermal infrared band;
microprocessor control means operatively connected to said electro-optical sensor means for digitally fusing the separate digital signal channels of real-time video data on a pixel-by-pixel basis to produce an enhanced digital image signal of the observed scene;
a housing for containing said electro-optical sensor means and said microprocessor control means, said housing being adapted for releasable attachment to a helmet worn by the personnel;
biocular display means attached to said housing and electrically connected to said microprocessor control means for displaying visual images of the observed scene based on the enhanced digital image signal; and
a power module adapted to engage the helmet and releasably connected to said housing for supplying operating voltages to said electro-optical sensor means, said microprocessor control means and said biocular display means.

9. A digital enhanced vision system according to claim 8, wherein said electro-optical sensor means comprises:
a long-wave thermal infrared sensor mounted within said housing having a micro-bolometer detector array forwardly facing in the direction of the observed scene; and
a short-wave infrared sensor mounted apart from said long-wave infrared sensor within said housing similarly facing in the direction of the observed scene,
wherein each of said infrared sensors produce a separate digital signal channel of real-time video data collected from the observed scene.

10. A digital enhanced vision system according to claim 8, wherein said electro-optical sensor means comprises:
a long-wave thermal infrared sensor mounted within said housing having a micro-bolometer detector array forwardly facing in the direction of the observed scene; and
a near-infrared sensor mounted apart from said long-wave infrared sensor within said housing similarly facing in the direction of the observed scene, said near-infrared sensor being a digital I-squared sensor,
wherein each of said infrared sensors produce a separate digital signal channel of real-time video data collected from the observed scene.

11. A digital enhanced vision system according to claim 9, wherein said microprocessor control means comprises:
a programmable video processor module operatively connected to said long-wave and short-wave infrared sensors to provide real-time digital processing of the respective signal channels of video data therefrom; and
mode control means for selectively fusing the respective signal channels of infrared image data or processing the respective signal channels separately.

12. A digital enhanced vision system according to claim 11, wherein said biocular display means comprises:
a pair of separate display modules each connected to said video processor module for producing the same resultant image on each module.

13. A digital enhanced vision system according to claim 12, further comprising:
a latch mechanism attached to said housing and adapted to engage a forward portion of the helmet, said latch mechanism being assembled having lever-like members extending therefrom to selectively lock the housing in place upon the helmet or enable a quick release thereof.

14. A digital enhanced vision system according to claim 13, wherein said power module is contoured and configured to conform to a rear portion of the helmet and be releasably mounted thereon in a position opposite to the mounted position of said housing.

15. A digital enhanced vision system according to claim 14, further comprising:
electrical cabling routed from said power module to said electro-optical sensor means, said microprocessor control means and said biocular display means; and
a rail bracket member mounted along the helmet and adapted in form to secure the routed cabling in place along either side thereof.

16. A digital enhanced vision system for use on a surveillance platform to provide improved visual images of an observed scene, comprising:
electro-optical sensor means for generating a pair of separate digital signal channels of real-time video data collected from the observed scene in distinct infrared bands, one of said pair of signal channels being in a long-wave thermal infrared band and the other being selected from either a near-infrared or short-wave infrared band;
microprocessor control means operatively connected to said electro-optical sensor means for digitally fusing the separate digital signal channels of real-time video data on a pixel-by-pixel basis to produce an enhanced digital image signal of the observed scene;
display means electrically connected to said microprocessor control means for displaying visual images of the observed scene based on the enhanced digital image signal; and
a power module for supplying operating voltages to said electro-optical sensor means, said microprocessor control means and said display means.

17. A digital enhanced vision system according to claim 16, further comprising:
a housing for containing said electro-optical sensor means and said microprocessor control means.

18. A digital enhanced vision system according to claim 17, wherein said electro-optical sensor means comprises:
a long-wave thermal infrared sensor mounted within said housing having a micro-bolometer detector array forwardly facing in the direction of the observed scene; and
a short-wave infrared sensor mounted apart from said long-wave infrared sensor within said housing similarly facing in the direction of the observed scene,
wherein each of said infrared sensors produce a separate digital signal channel of real-time video data collected from the observed scene.

19. A digital enhanced vision system according to claim 17, wherein said electro-optical sensor means comprises:
a long-wave thermal infrared sensor mounted within said housing having a micro-bolometer detector array forwardly facing in the direction of the observed scene; and
a near-infrared sensor mounted apart from said long-wave infrared sensor within said housing similarly facing in the direction of the observed scene, said near-infrared sensor being a digital I-squared sensor,
wherein each of said infrared sensors produce a separate digital signal channel of real-time video data collected from the observed scene.

20. A digital enhanced vision system according to claim 18, wherein said microprocessor control means comprises:
a programmable video processor module operatively connected to said long-wave and short-wave infrared sensors to provide real-time digital processing of the respective signal channels of video data therefrom; and
mode control means for selectively fusing the respective signal channels of infrared image data or processing the respective signal channels separately.
